(19) United States
(12) Patent Application Publication
(10) Pub. No.: US 2005/0000599 A1
(43) Pub. Date: Jan. 6, 2005

(54) Amorphous and nanocrystalline glass-coated articles

(76) Inventors: Howard H. Liebermann, Succasunna, NJ (US); William C. LaCourse, Alfred, NY (US)

Correspondence Address: ERNEST D BUFF & ASSOCIATES, LLC, 245 SOUTH ST, MORRISTOWN, NJ, 07960, US

(21) Appl. No.: 10/881,760

(22) Filed: Jun. 30, 2004

Related U.S. Application Data
(60) Provisional application No. 60/484,735, filed on Jul. 3, 2003.

(51) Int. Cl. B32B 15/04; H01F 1/01

(52) U.S. Cl. 148/300; 428/433; 428/379

(57) ABSTRACT

A drawn glass-coated metallic member has a thermal contraction coefficient differential such that the thermal contraction coefficient of the glass is less than that of the metallic member. The thermal contraction coefficient differential is maintained within a predetermined range during drawing. The glass is placed under residual compression, interfacial bonding between said glass and said wire is substantially uniform, and surface cracking and bond breaks between metal and glass are substantially prevented. A dynamic balance is maintained between the surface tension of the molten alloy and the resistance to high temperature deformation by the glass vessel in which it is contained, enabling the production of glass-coated amorphous or nanocrystalline alloy members having predefined cross-sectional shapes.

This application claims the benefit of Application No.: 60/484,735, filed Jul. 3, 2003.

### BACKGROUND OF THE INVENTION

1. Field of the Invention

This invention relates to glass-coated amorphous or nanocrystalline alloys; and more particularly, to long, slender articles that are composed of such alloys and have predetermined cross-sectional shapes.

2. Description of the Prior Art

Glass-coated amorphous and nanocrystalline alloy microwire and its production have been disclosed in the technical and patent literature [U.S. Pat. No. 6,270,591/Aug. 7, 2001 and U.S. Pat. No. 5,240,066/Aug. 31, 1993, Horia Chirac, “Preparation and Characterization of Glass Covered Magnetic Wires”, Materials Science and Engineering A304-306 (2001) pp. 166-171]. Continuous lengths have been produced by melting either a pre-alloyed ingot or the required elemental constituents in a generally vertically disposed glass tube that is sealed at the bottom. Once the alloy is converted to a molten state, using radio frequency (“r.f.”) heating for example, the softened bottom of the glass tube is grasped and drawn into continuous microwire or fiber. Rapid reduction of alloy cross-section, together with use of secondary cooling means, cause the alloy to become amorphous or nanocrystalline during drawing. The technical and patent literature suggests use of nominally round glass tubing for this glass-coated microwire drawing process. Products resulting from such microwire drawing processes typically exhibit circular cross-sections.

One of the major problems with microwire produced by the aforementioned process is the difficulty of efficiently producing wound components therefrom. The circular cross-section of the microwire limits winding efficiencies, with the result that spatial fill factors for the wound components are typically less than about 50-60%.

Accordingly, there exists a need in the art for glass-coated amorphous and nanocrystalline members that can be efficiently produced into wound components having high spatial fill factor.

### SUMMARY OF THE INVENTION

The present invention provides an article composed of a glass-coated amorphous or nanocrystalline alloy, and a process for producing the article. Such an article can have a cross-sectional geometry that can be substantially rectangular, or which exhibits a variety of other cross-sectional geometric shapes. Advantageously, it has been found that the use of glass preforms having certain predetermined shapes enables the production of articles having corresponding shapes when utilized in combination with a process for drawing glass-coated amorphous or nanocrystalline metallic alloy wire. Maintenance of a dynamic balance between the surface tension of the molten alloy and the resistance to high temperature deformation by the glass vessel in which it is contained enables the production of glass-coated amorphous or nanocrystalline alloy articles having predefined cross-sectional shapes.

In addition, the invention provides a method for producing a glass-coated article having either circular cross-section or substantially rectangular cross-section and a metallic alloy core. Generally stated, the method comprises the steps of forming a melt of the metallic alloy in a hollow glass preform having a circular cross-section or substantially rectangular cross-section; drawing the glass perform to entrain and rapidly solidify molten alloy while simultaneously providing a glass coating; placing said glass coating under residual compression during said drawing step, so that interfacial bonding between said glass and said metallic alloy core is substantially uniform and surface cracking and bond breaks between the metallic alloy and glass are substantially prevented.

Numerous, highly advantageous uses for glass-coated articles produced in accordance with the present invention are disclosed hereinafter in greater detail.

### BRIEF DESCRIPTION OF THE DRAWINGS

The invention will be more fully understood and further advantages will become apparent when reference is had to the following detailed description and the accompanying drawings, in which:

FIG. 1 is a perspective view showing a conventional (round) glass-coated microwire (article) produced by drawing from a round glass tube;

FIG. 2 is a perspective view showing the a substantially rectangular cross-sectional glass-coated article in accordance with the present invention, the article having been produced by drawing from a hollow glass preform having a substantially rectangular cross-section;

FIG. 3 is a perspective view showing a substantially rectangular cross-sectional glass-coated article of the present invention, the article having been produced by drawing from a hollow glass preform having a substantially rectangular cross-section using a radio frequency magnetic field to maintain geometric uniformity; and

FIG. 4 is a perspective view showing a substantially rectangular cross-sectional glass-coated article of the invention, the article having been produced by drawing from a hollow glass preform having a substantially rectangular cross-section using a driven mechanical roller means to maintain geometric uniformity.

### DETAILED DESCRIPTION OF THE INVENTION

As used herein, the term “amorphous metallic alloy” means a metallic alloy that substantially lacks any long-range order and is characterized by x-ray diffraction intensity maxima that are qualitatively similar to those observed for liquids or oxide glasses. By way of contrast, the term “nanocrystalline metallic alloy” pertains to those metallic alloys having constituent grain sizes on the order of nanometers.

The term “glass”, as used throughout the specification and claims, refers to an inorganic product of fusion that has cooled to the solid state without crystallizing, or to glassy materials formed by chemical means such as a sol-gel process, or by “soot” processes, both of which are used to form glass preforms that are used in fiber optic processing. These materials are not fused; but rather are consolidated at high temperatures, generally below the fusion temperatures of the constituents in question.

The term “drawing”, as used herein, refers to the extension of a material using a tensile force, the extension resulting in a permanent reduction of the material's cross-sectional area.

The term “article”, as used herein, refers to a long geometric body having any number of cross-sectional shapes, including circular (wire, rod, ribbon, fiber, etc.).

The term “fiber”, as used herein, refers to a thin element, which may be continuous or non-continuous, of circular or non-circular cross-section, and which has a transverse dimension less than about 50 μm.

The term “microwire”, as used herein, means a fiber that is present as a single element or as multiple elements, and comprises at least one metallic material.

The term “preform”, as used herein, means the glass vessel in which alloy is melted and drawing into a member.

The terms “liquidus temperature” and “liquidus”, as used herein, refer to the temperature above which there exist no stable crystalline phases in the material.

The terms “surface energy” and “surface tension”, as used herein, refer to the energy or tension that arises when the molecules at a surface do not have other like molecules on all sides of them, thus resulting in unbalanced bonds at the surface (surface energy) and the resulting force (surface tension)

The term “spatial fill factor”, as used herein, refers to the ratio of actual space occupied to that which is theoretically available.

The term “thermal contraction coefficient”, as used herein, refers to the amount of length change of a material per unit length of that material, and per unit temperature, when the material is cooled from a high temperature to a low temperature.

The terms “annealing temperature” and “annealing point”, as used herein, refer to the temperature at which the viscosity of a glass is 10¹² Pa-sec.

The term “strain point”, as used herein, refers to the temperature at which the viscosity of a glass is 10^{13.5} Pa-sec.

The terms “working temperature” and “working point”, as used herein, refer to the temperature at which a glass has a viscosity of 10³ Pa-sec.

The term “magnetostriction”, as used herein refers to the change in dimensions of a magnetic material when subjected to a magnetic field.

In comparison with the casting of amorphous or of nanocrystalline metallic alloy ribbon using a metallic substrate surface such as a quenching wheel, a glass-coated member has topologically and chemically identical surfaces. Furthermore, the glass in contact with the molten alloy during drawing effectively acts as a slag with which the alloy has intimate physical contact. The result is that the surface of the solidified alloy in a glass-coated article is much smoother than that of ribbon that is cast on a quenching wheel. This results in much improved mechanical strength because of the fewer number and smaller size of possible stress-rising defects. Also, magnetization reversal is greatly facilitated, again because of the smoother metallic alloy surface in glass-coated members. In fact, the lack of surface smoothness of rapidly solidified magnetic amorphous metallic alloy ribbon imposes a minimum thickness of dielectic ribbon that must be co-wound when constructing a specialty magnetic core in order to ensure a minimum stand-off voltage between magnetic windings during the operation of said core. By way of contrast, the surface of the alloy resulting from the glass-coated process allows the use of thinner electrically insulating layers to be used. In fact, the glass coating itself acts as the insulating layer, thus obviating the need for any co-winding operations that are required for the ribbon-based magnetic core.

Limitations heretofore imposed by use of circular glass-coated amorphous or nanocrystalline metallic articles are, advantageously, overcome through use amorphous or nanocrystalline alloy articles of the present invention, which can have substantially rectangular cross-sections. One method for producing these substantially rectangular cross-sectional members comprises use of a glass tube having a rectangular cross-section during the alloy melting stage of the glass-coated article drawing operation. Care must be taken, however, so that the high surface energy of the metallic alloy (about 1,500 mN/m) does not cause mechanical bowing deformation of the glass tube during drawing of the glass-coated amorphous or nanocrystalline alloy article member. In fact, the mechanical strength of the hollow rectangular glass preform wall must be great enough to withstand the normal forces created by the molten alloy surface tension. These forces act to minimize the alloy's surface energy or surface area by changing its shape to approach that of a circular shape, rather than maintaining a flat interface with the glass. It has been found that this consideration of mechanical rigidity for the glass must be addressed for every non-circular cross-sectional shape of the amorphous or nanocrystalline metallic alloy article being drawn. Use of amorphous or nanocrystalline metallic alloy articles having non-circular cross-sectional shapes advantageously enables use of thinner insulation for said articles. Therefore, a greater fraction of the magnetic core can be comprised of magnetic material, as opposed to dielectric insulator. Magnetic core performance is significantly improved. The magnetic components constructed in accordance with the invention are smaller in size, lighter in weight, less expensive to construct and more efficient in operation than cores produced from amorphous or nanocrystalline metallic alloy ribbon in conjunction with separately applied surface insulation using prior art methods.

There are other, more difficult means by which the potentially deleterious surface energy effects of the molten metallic alloy can be mitigated. For example, it is well known in the art [M. Garnier, “Electromagnetic Processing of Liquid Materials in Europe”, ISIJ International 30 (1) (1990) pp. 1-7, Nagy El-Kaddah and F. A. Acosta-Gonzales, “Mathematical Model for the Shaping of Molten Metal by an Electromagnetic Field”, Casting of Near Net Shape Products, edited by Y. Sahai, J. E. Battles, R. S. Carbonara, and C. E. Mobley, TMS (1988) pp. 423-437] that surface waves on the free surface of molten metallic alloys can be suppressed in free falling metallic alloy streams, which are shaped by prudently applying a radio frequency magnetic field at the surface of the molten metallic alloy. With this approach, the deleterious effects of molten metallic alloy surface energy—a driving force that results in mechanical bowing deformation or other geometric distortions of the glass vessel—is significantly reduced. Furthermore, reduction of edge roughness also results.

Another arrangement involves the use of a pair of closely disposed and driven mechanical rollers, either heated or not, placed very close to the end of the “necking” point of an article during drawing. With this placement of the mechanical rollers there is provided a force normal to the glass-coated, substantially rectangular cross-sectioned article. The normal force counteracts any tendency for mechanical bowing deformation of the hollow glass preform during drawing, which may be present as the result of high surface energy within the molten metallic alloy.

One of the most troublesome problems encountered when casting amorphous metallic alloy ribbon on a quenching substrate is the formation of tiny depressions in the underside of the ribbon during casting. These depressions are the result of entrainment of gas from the boundary layer associated with the rapidly moving substrate surface. The local ribbon surface chemistry within these gas pockets in the solidified ribbon is oftentimes deficient in both boron and silicon. Surface oxidation on the ribbon underside predisposes the material to undesirable crystallization, causing degradation of engineering properties. Advantageously, with glass-coated amorphous alloy articles this phenomenon is virtually eliminated. When compared to quench surface-cast amorphous metallic alloy ribbon, glass-coated articles of the invention exhibit enhanced resistance to crystallization and therefore have greater thermal stability.

A major limitation encountered during casting of very thin (less than about 15 μm thick) amorphous metallic alloy ribbon on a quenching wheel is the tendency of resulting ribbon asperities to become significant in size in comparison to the thickness of the ribbon itself. This can result in disproportionately large, unacceptable surface features, including perforations in the thin ribbon. Such geometric features seriously degrade magnetic and mechanical performance. Advantageously, metallic alloy articles produced by glass-coated drawing have no such thinness limitation. Hence, amorphous metallic alloy cores formed from glass-coated articles can be substantially thinner than those of thin quench surface-cast ribbon. These features result in dramatically reduced magnetic core losses, since such magnetic core losses decrease sharply in direct proportion to the decrease in a magnetic article's cross-section.

One illustrative example highlighting value added by practice of the present invention involves the co-winding of dielectric and magnetic tapes during manufacture of specialty magnetic cores. An exceedingly thin (less than about 15 μm) and smooth substantially rectangular cross-sectioned metallic alloy article, combined with the exceptionally thin dielectric glass coating that results from the drawing process, endow the glass-coated amorphous or nanocrystalline metallic alloy of the invention with unique and valuable properties. Advantageously, products produced in accordance with the teachings of the present invention are demonstrate superior performance because they are comprised of thinner magnetic and dielectric constituent layers than appears in the prior art. These attributes provide special magnetic cores of the invention with performance properties exhibiting significant improvement over conventionally produced cores. A further advantage of the instant technology resides in the process for making the specialty magnetic core. Such a process is less complex, requiring winding of a single article, whereas conventional processes necessitate co-winding of magnetic and dielectric constituent elements. When practiced in conjunction with certain metals and also with metallic alloys that are neither amorphous nor nanocystalline, the method and apparatus of the present invention will produce articles that can be advantageously used to manufacture electrical capacitors, light-tight food packaging, and a wide variety of other useful applications.

Throughout the specification and the appended claims, the process of this invention has been described with reference to a glass-coated article cross-section. It will be appreciated, however, that the principles of the invention are applicable, as well, to variously shaped articles, the cross-sections of which are other than rectangular.

The teaching of the present invention can be used in conjunction with metallic alloys having various compositions, whether such alloys are amorphous, nanocrystalline, or otherwise. The present invention can also be with various kinds of glasses of which the preforms are made.

The following examples are presented to provide a more complete understanding of the invention. The specific techniques, conditions, materials, proportions and reported data set forth to illustrate the principles and practice of the invention are exemplary and should not be construed as limiting the scope of the invention.

### EXAMPLE 1

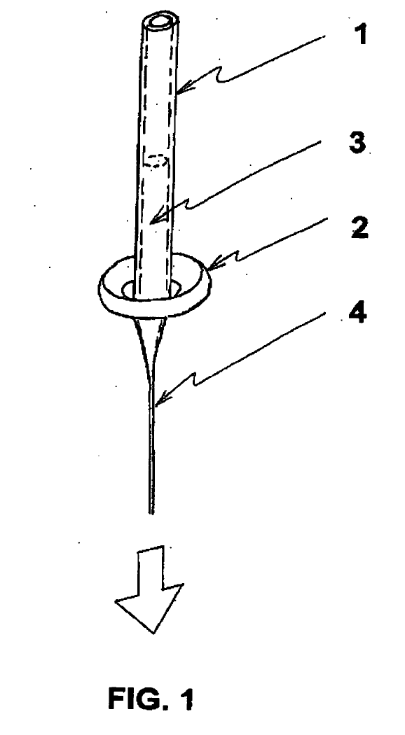

An ingot composed of an amorphous-forming metallic alloy is prepared by loading the appropriate weights of constituent elements into a quartz tube that is sealed at one end. The other end of this quartz tube is connected to a pressure-vacuum system to allow evacuation and back-filling with Ar gas several times to ensure a low oxygen Ar atmosphere within the quartz tube. Next, the closed end of the quartz tube in which the elements reside is introduced into a high frequency induction-heating coil. With the application of radio frequency (“r.f.”) power, the elements inside the tube are caused to heat and melt into a stirred, homogeneous metallic alloy body. When the r.f. power is shut off, the alloy body is allowed to cool to room temperature in the Ar atmosphere. Once cooled, the same metallic alloy body is inserted into the bottom of a vertically disposed glass tube 1 (preform), having 6-mm diameter that is sealed at the lower end, as depicted in FIG. 1. The upper end of this preform is connected to a pressure-vacuum system to allow evacuation and back-filling with Ar gas several times to ensure a low oxygen Ar atmosphere within the quartz tube. A specially built inductor 2 at the bottom of the preform is energized with r.f. power in order to heat and then melt the metallic alloy body 3 within the tube. Once the metallic alloy body is molten and heated above its liquidus temperature by some 20 to 50° C., a solid glass rod is used to touch and bond to the bottom of the sealed glass preform in which the molten metallic alloy resides. The heat of the molten metallic alloy softens the glass preform allowing it to be drawn by pulling on the glass rod to which it is attached. Molten metallic alloy is entrained in the drawn glass capillary 4 that results. The drawn capillary is then pulled and guided onto a spinning take-up spool, which provides both winding tension to ensure continuous drawing at a rate of about 5 meters/second and a systematically wound article (microwire) package.

Amorphous glass-coated microwire about 30 μm in diameter is produced using the procedure described above. The microwire has an Fe_{77.5}B₁₅Si_{7.5} amorphous alloy core that is under axial tensile stress. The glass from which the preform was made, and which coats the microwire, is a low-expansion borosilicate having the approximate composition set forth below:

| Constituent | Weight % |
|---|---|
| SiO₂ | 80 |
| B₂O₃ | 13 |
| Al₂O₃ | 3 |
| Na₂O | 4 |

| | |
|---|---|
| Working Point | 1,256° C. |
| Assumed set point = | 565° C. (depends |
| Annealing Point = | on cooling rate) |
| Elastic Modulus | 80 GPa |
| α_{gl} (Annealing pt. − 25° C.) | 3.5 ppm ° C.⁻¹. |

The metallic alloy used to form the microwire has the following properties:

| | |
|---|---|
| Liquidus | 1,230° C. |
| Elastic Modulus | 200 GPa |
| αₐ | 8.0 ppm ° C.⁻¹. |

The working point of this glass is slightly higher than the liquidus temperature of the metallic alloy, but within limits that allow easy article formation.

### EXAMPLE 2

An amorphous glass-coated article having a substantially rectangular rather than a circular cross-section is prepared by the procedure described in Example 1, except that a hollow substantially rectangular rather than a hollow round glass preform is now used.

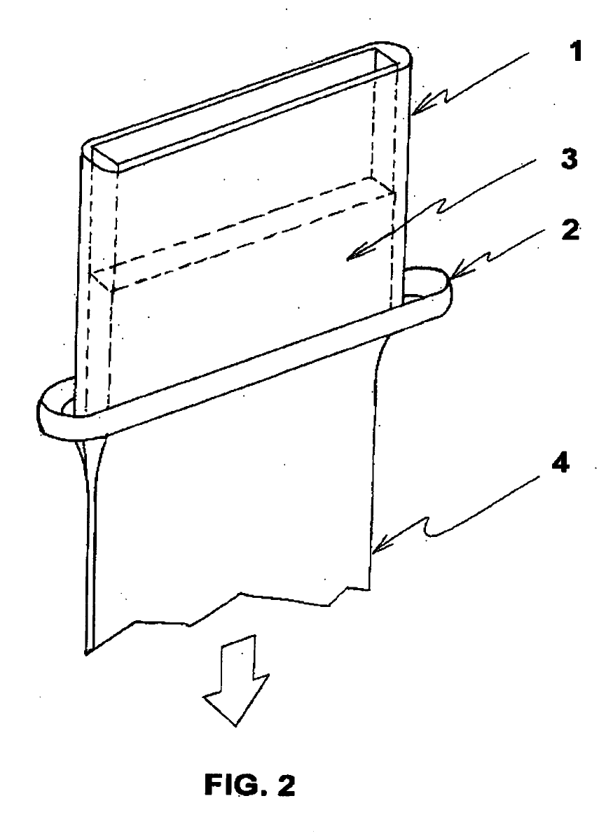

A pre-melted metallic alloy body is inserted into the bottom of a vertically disposed hollow substantially rectangular glass preform 1, having 6-mm×50-mm internal cavity that is sealed at the lower end, as depicted in FIG. 2. The upper end of this preform is connected to a pressure-vacuum system to allow evacuation and back-filling with Ar gas several times to ensure a low oxygen Ar atmosphere within the quartz tube. A specially built inductor 2 at the bottom of the preform is energized with r.f. power in order to heat and then melt the metallic alloy body 3 within the preform. Once the metallic alloy body is molten and heated above its liquidus temperature by some 20 to 50° C., a solid glass plate is used to touch and bond to the bottom of the sealed glass preform in which the molten metallic alloy resides. The heat of the metallic molten softens the glass preform allowing it to be drawn by pulling on the glass plate to which it is attached. Molten metallic alloy is entrained in the drawn glass capillary that results. The drawn ribbon 4 is then pulled and guided onto a spinning take-up spool, which provides both winding tension to ensure continuous drawing at a rate of about 5 meters/second and a systematically wound article (ribbon) package.

Amorphous glass-coated member in the form of ribbon about 30 μm thick and about 45 mm wide is produced using the procedure described above. The ribbon has an Fe_{77.5}B₁₅Si_{7.5} amorphous alloy core that is under axial tensile stress. The glass from which the preform was made, and which coats the microwire, is a low-expansion borosilicate having the approximate composition set forth below:

| Constituent | Weight % |
|---|---|
| SiO₂ | 80 |
| B₂O₃ | 13 |
| Al₂O₃ | 3 |
| Na₂O | 4 |

| | |
|---|---|
| Working Point | 1,256° C. |
| Assumed set point = | 565° C. (depends |
| Annealing Point = | on cooling rate) |
| Elastic Modulus | 80 GPa |
| α_{gl} (Annealing pt. − 25° C.) | 3.5 ppm ° C.⁻¹. |

The metallic alloy used to form the ribbon has the following properties:

| | |
|---|---|
| Liquidus | 1,230° C. |
| Elastic Modulus | 200 GPa |
| αₐ | 8.0 ppm ° C.⁻¹. |

The working point of this glass is slightly higher than the liquidus temperature of the alloy, but within limits that allow easy article formation.

### EXAMPLE 3

An amorphous glass-coated article having a substantially rectangular rather than a circular cross-section is prepared by the procedure described in Example 1, except that a hollow substantially rectangular rather than a hollow round glass preform is now used.

A pre-melted metallic alloy body is inserted into the bottom of a vertically disposed hollow substantially rectangular glass preform 1, having 6-mm×50-mm internal cavity that is sealed at the lower end, as depicted in FIG. 2. The upper end of this preform is connected to a pressure-vacuum system to allow evacuation and back-filling with Ar gas several times to ensure a low oxygen Ar atmosphere within the quartz tube. A specially built inductor 2 at the bottom of the preform is energized with r.f. power in order to heat and then melt the metallic alloy body 3 within the preform. Once the metallic alloy body is molten and heated above its liquidus temperature by some 20 to 50° C., a solid glass plate is used to touch and bond to the bottom of the sealed glass preform in which the molten metallic alloy resides. The heat of the metallic molten alloy softens the glass preform allowing it to be drawn by pulling on the glass plate to which it is attached. Molten metallic alloy is entrained in the drawn glass capillary that results. The drawn ribbon 4 is then pulled and guided onto a spinning take-up spool, which provides both winding tension to ensure continuous drawing at a rate of about 5 meters/second and a systematically wound article (ribbon) package.

Amorphous glass-coated member in the form of ribbon about 30 μm thick and about 45 mm wide is produced using the procedure described above. The ribbon has an Fe_{73.5}Cu₁Nb₃B₉Si_{13.5} amorphous alloy core that is under axial tensile stress. The glass from which the preform was made, and which coats the microwire, is a low-expansion borosilicate having the approximate composition set forth below:

| Constituent | Weight % |
|---|---|
| SiO₂ | 80 |
| B₂O₃ | 13 |
| Al₂O₃ | 3 |
| Na₂O | 4 |

| | |
|---|---|
| Working Point | 1,256° C. |
| Assumed set point = | 565° C. (depends |
| Annealing Point = | on cooling rate) |
| Elastic Modulus | 80 GPa |
| α_{gl} (Annealing pt. − 25° C.) | 3.5 ppm ° C.⁻¹. |

The metallic alloy used to form the ribbon has the following properties:

| | |
|---|---|
| Liquidus | 1,230° C. |
| Elastic Modulus | 200 GPa |
| αa | 8.0 ppm ° C.⁻¹. |

The working point of this glass is slightly higher than the liquidus temperature of the alloy, but within limits that allow easy article formation. Once drawn, the glass-coated amorphous metallic alloy article is subject to thermally treatment at 550° C. for 1 hour in order to now obtain a glass-coated nanocrystalline alloy article. The said thermal treatment is done with the article in Ar or some other protective atmosphere to prevent oxidation.

### EXAMPLE 4

An amorphous glass-coated article having a substantially rectangular rather than a circular cross-section is prepared by the procedure described in Example 2, except that a substantially rectangular definition of the article drawn is ensured by the use of electromagnetic shaping means.

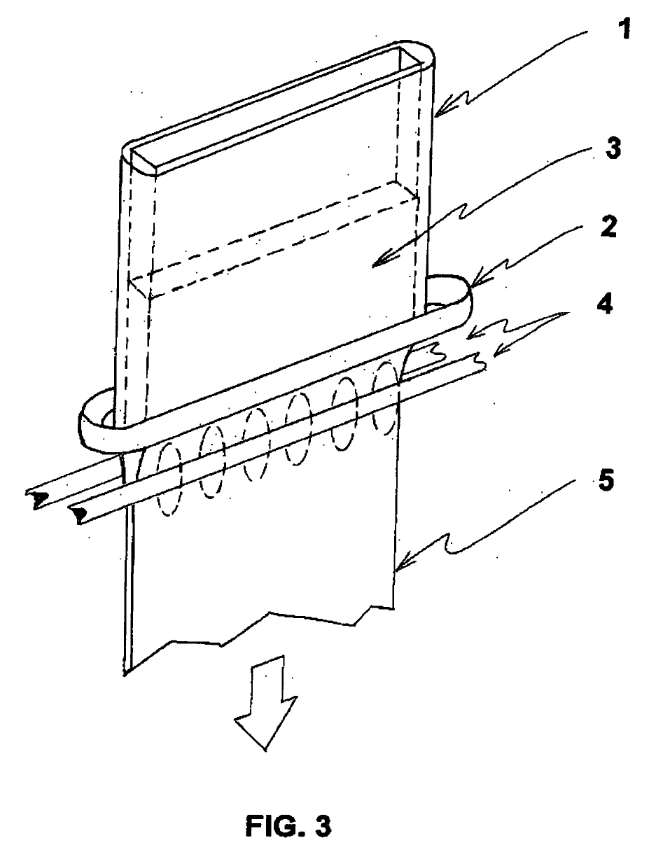

A pre-melted metallic alloy body is inserted into the bottom of a vertically disposed hollow substantially rectangular glass preform 1, having 6-mm×50-mm internal cavity that is sealed at the lower end, as depicted in FIG. 3. The upper end of this preform is connected to a pressure-vacuum system to allow evacuation and back-filling with Ar gas several times to ensure a low oxygen Ar atmosphere within the quartz tube. A specially built inductor 2 at the bottom of the preform is energized with r.f. power in order to heat and then melt the metallic alloy body 3 within the preform. Once the metallic alloy body is molten and heated above its liquidus temperature by some 20 to 50° C., a solid glass plate is used to touch and bond to the bottom of the sealed glass preform in which the molten metallic alloy resides. The heat of the molten metallic softens the glass preform allowing it to be drawn by pulling on the glass plate to which it is attached. Molten metallic alloy is entrained in the drawn glass capillary that results. Magnetically-induced pressure on the surface of the ribbon thus formed is created by the flow of at least 50 A electrical current through the linear inductor 4 that is in close proximity to the each of the surfaces of the glass-coated ribbon that is being drawn. The drawn ribbon 5 is then pulled and guided onto a spinning take-up spool, which provides both winding tension to ensure continuous drawing at a rate of about 5 meters/second and a systematically wound article (ribbon) package.

An amorphous glass-coated member in the form of a ribbon about 30 μm thick and about 45 mm wide is produced using the procedure described above. The ribbon has an Fe_{77.5}B₁₅Si_{7.5} amorphous alloy core that is under axial tensile stress. The glass from which the preform was made, and which coats the microwire, is a low-expansion borosilicate having the approximate composition set forth below:

| Constituent | Weight % |
|---|---|
| SiO₂ | 80 |
| B₂O₃ | 13 |
| Al₂O₃ | 3 |
| Na₂O | 4 |

| | |
|---|---|
| Working Point | 1,256° C. |
| Assumed set point = | 565° C. (depends |
| Annealing Point = | on cooling rate) |
| Elastic Modulus | 80 GPa |
| α_{gl} (Annealing pt. − 25° C.) | 3.5 ppm ° C.⁻¹. |

The metallic alloy used to form the ribbon has the following properties:

| | |
|---|---|
| Liquidus | 1,230° C. |
| Elastic Modulus | 200 GPa |
| αₐ | 8.0 ppm ° C.⁻¹. |

The working point of this glass is slightly higher than the liquidus temperature of the alloy, but within limits that allow easy article formation.

### EXAMPLE 5

An amorphous glass-coated article having a substantially rectangular rather than a circular cross-section is prepared by the procedure described in Example 2, except that substantially rectangular definition of the article drawn is ensured by the use of a counter rotating mechanical roller means.

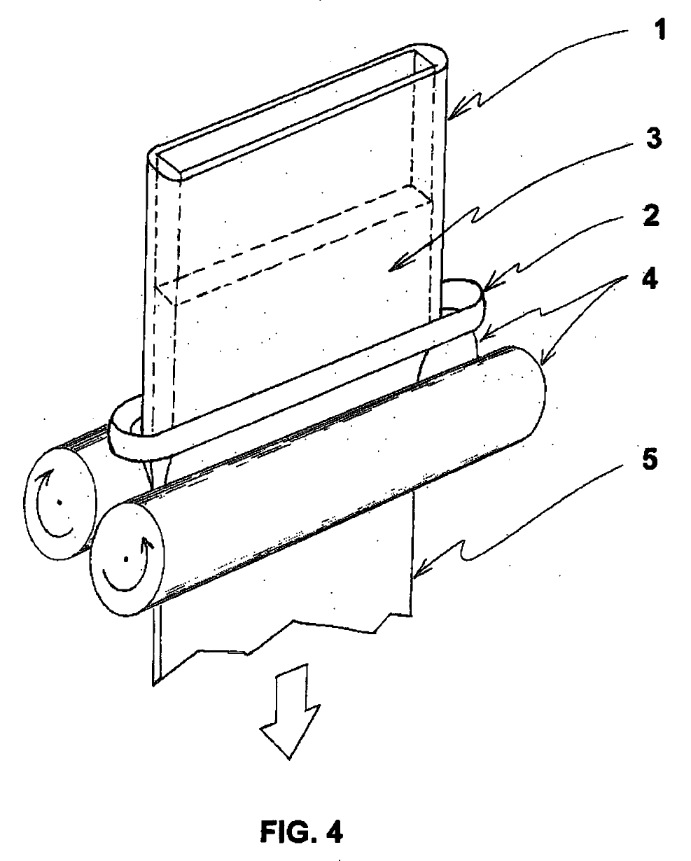

A pre-melted metallic alloy body is inserted into the bottom of a vertically disposed hollow substantially rectangular glass preform 1, having 6-mm×50-mm internal cavity that is sealed at the lower end, as depicted in FIG. 4. The upper end of this preform is connected to a pressure-vacuum system to allow evacuation and back-filling with Ar gas several times to ensure a low oxygen Ar atmosphere within the quartz tube. A specially built inductor 2 at the bottom of the preform is energized with r.f. power in order to heat and then melt the metallic alloy body 3 within the preform Once the metallic alloy body is molten and heated above its liquidus temperature by some 20 to 50° C., a solid glass plate is used to touch and bond to the bottom of the sealed glass preform in which the molten metallic alloy resides. The heat of the molten metallic softens the glass preform allowing it to be drawn by pulling on the glass plate to which it is attached. Molten metallic alloy is entrained in the drawn glass capillary that results. Mechanically induced pressure on the surfaces of the ribbon thus formed is created through the use of counter-rotating, possibly driven and heated, rollers 4. The drawn ribbon 5 is then pulled and guided onto a spinning take-up spool, which provides both winding tension to ensure continuous drawing at a rate of about 5 meters/second and a systematically wound article (ribbon) package.

Amorphous glass-coated member in the form of ribbon about 30 μm thick and about 45 mm wide is produced using the procedure described above. The ribbon has an Fe_{77.5}B₁₅Si_{7.5} amorphous alloy core that is under axial tensile stress. The glass from which the preform was made, and which coats the microwire, is a low-expansion borosilicate having the approximate composition set forth below:

| Constituent | Weight % |
|---|---|
| SiO₂ | 80 |
| B₂O₃ | 13 |
| Al₂O₃ | 3 |
| Na₂O | 4 |

| | |
|---|---|
| Working Point | 1,256° C. |
| Assumed set point = | 565° C. (depends |
| Annealing Point= | on cooling rate) |
| Elastic Modulus | 80 GPa |
| α_{gl} (Annealing pt. − 25° C.) | 3.5 ppm ° C.⁻¹. |

The metallic alloy used to form the ribbon has the following properties:

| | |
|---|---|
| Liquidus | 1,230° C. |
| Elastic Modulus | 200 GPa |
| αₐ | 8.0 ppm ° C.⁻¹. |

The working point of this glass is slightly higher than the liquidus temperature of the alloy, but within limits that allow easy article formation.

Having thus described the invention in rather full detail, it will be understood that such detail need not be strictly adhered to but that various changes and modifications may suggest themselves to one skilled in the art, all falling within the scope of the present invention as defined by the subjoined claims.

1. In an article having a glass-coated metallic alloy core, the improvement wherein:
a. said glass and said metallic alloy core have a thermal contraction coefficient differential, said thermal contraction coefficient of said glass being less than that of said metallic alloy core; and
b. said thermal contraction coefficient differential has a predetermined value such that said glass is placed under residual compression, interfacial bonding between said glass and said wire is substantially uniform, and surface cracking and bond breaks between metal and glass are substantially prevented.

2. An article as recited by claim 1, in which said metallic alloy core is magnetic.

3. An article as recited by claim 2, in which said metallic alloy core is amorphous.

4. An article as recited by claim 3, in which said metallic alloy core has positive saturation magnetostriction ranging from about 1 to 40 ppm.

5. An article as recited by claim 3, in which said metallic alloy core has positive saturation magnetostriction ranging from about 11 to 40 ppm.

6. An article as recited by claim 3, in which said metallic alloy core has positive saturation magnetostriction ranging from about 20 to 40 ppm.

7. An article as recited by claim 3, in which said metallic alloy core has negative saturation magnetostriction ranging from about −1 to −30 ppm.

8. An article as recited by claim 3, in which said metallic alloy core has negative saturation magnetostriction ranging from about −1 to −10 ppm.

9. An article as recited by claim 3, in which said metallic alloy core has negative saturation magnetostriction ranging from about −1 to −5 ppm.

10. An article as recited by claim 1, in which said metallic alloy core is nanocrystalline.

11. An article as recited by claim 10, in which said metallic alloy core is magnetic.

12. An article as recited by claim 10, in which said metallic alloy core has positive saturation magnetostriction ranging from about 1 to 40 ppm.

13. An article as recited by claim 10, in which said metallic alloy core has positive saturation magnetostriction ranging from about 11 to 40 ppm.

14. An article as recited by claim 10, in which said metallic alloy core has positive saturation magnetostriction ranging from about 20 to 40 ppm.

15. An article as recited by claim 10, in which said metallic alloy core has negative saturation magnetostriction ranging from about −1 to −30 ppm.

16. An article as recited by claim 10, in which said metallic alloy core has negative saturation magnetostriction ranging from about −1 to −10 ppm.

17. An article as recited by claim 10, in which said metallic alloy core has negative saturation magnetostriction ranging from about −1 to −5 ppm.

18. A method for producing a glass-coated article having circular cross-section and a metallic alloy core, comprising the steps of:
a. forming a melt of said metallic alloy in a hollow glass preform having circular cross-section;
b. drawing said glass preform to entrain and rapidly solidify molten alloy while simultaneously providing a glass coating; and
c. placing said glass coating under residual compression during said drawing step, so that interfacial bonding between said glass and said metallic alloy core is substantially uniform and surface cracking and bond breaks between the metallic alloy and glass are substantially prevented.

19. A method for producing a glass-coated article having substantially rectangular cross-section and a metallic alloy core, comprising the steps of:
a. forming a melt of said metallic alloy in a hollow glass preform having substantially rectangular cross-section;
b. drawing said glass preform to entrain and rapidly solidify molten alloy while simultaneously providing a glass coating; and
c. placing said glass coating under residual compression during said drawing step, so that interfacial bonding between said glass and said metallic alloy core is substantially uniform and surface cracking and bond breaks between the metallic alloy and glass are substantially prevented.
